(19) United States
(12) Patent Application Publication
(10) Pub. No.: US 2005/0162507 A1
(43) Pub. Date: Jul. 28, 2005

(54) Video communication method of internet protocol phone

(76) Inventor: Hung-Yeh Du, Taipei (TW)

Correspondence Address: RABIN & BERDO, P.C., Suite 500, 1101 14 Street, N.W., Washington, DC, 20005, US

(21) Appl. No.: 10/762,484

(22) Filed: Jan. 23, 2004

(51) Int. Cl. H04N 7/14; H04Q 11/00; H04L 12/16

(52) U.S. Cl. 348/14.01; 370/260

(57) ABSTRACT

In a video communication method, an IP phone is provided with a video-compatible functionality so that video data can be received from a remote communication terminal. When video data are received, the status of a video-processing device connected to the IP phone is detected. If it is in an activation state, the video-processing device receives the video data from the voice network telephone, and processes them via a video compression/decompression module for being displayed a display module. The video-processing device is further equipped with an image pickup module, that captures incoming video signals which are turned to the compressed video data through the video compression/decompression module, and then transmitted through the IP phone to the communication terminal.

### BACKGROUND OF THE INVENTION

1. Field of Invention

The present invention relates to video communication method implemented with an IP phone, and more particularly to an IP phone capable of conducting video communication.

2. Related Art

The development of broadband Internet connection such as ADSL allows longer computer connection to the network. This technical progress allows the efficient development and implementation of new services not possible before, such as Internet network television or Internet network telephony. In the field of telephony, voice over Internet protocol (VoIP) has been created to transmit voice data through the Internet network between two or more network terminals, equipped with telephone with VoIP functionality (also called a network telephone).

In the early age of Internet, data transmission through the network was technically limited due to transmission speed. The use of low-resolution data compression formats in Internet telephony then usually results in unclear sound, while high-resolution data compression formats lead to large data packets which are transmitted at a slow rate through the network, often resulting in intermittently interrupted sound reception.

Broadband network connection enables substantially faster data transmission, and therefore allows bigger sound sampling compression close to the telephonic sound bandwidth. In addition to sound data, video data sampling at 1000 k/second into dynamic RM files has become possible, so that video transmission through the Internet is increasingly popular. Network telephony presently includes three different configurations: computer-to-telephone, computer-to-computer, and telephone-to-telephone configurations. Computer-to-telephone communication usually requires a specifically equipped network telephone communicating through ADSL or cable connection. In this type of telephony, the user conventionally has to subscribe for a user account to the VoIP service provider and buy a specific software program to be installed on the computer, as well as earphones and a microphone. The VoIP service provider then switches the computer user to communicate with the network telephone. Computer-to-computer telephony usually needs the users on both computer terminals to install a specific software program and, equipped with earphones and microphones, telephonic communication then can be simply established. Well-known examples of computer-to-computer telephony include the I-Phone system, or MSN Message systems. Finally, telephone-to-telephone communication is conventionally implemented via switch techniques with a fixed network. However, due to the high equipment costs of the management server, telephone-to-telephone communication is usually operated by private telephony companies.

On the other hand, current network telephone equipment having a display screen and an image pickup device is significantly expensive for the basic consumer. Video/audio telephony therefore is still not accessible to a large number of consumers.

### SUMMARY OF THE INVENTION

It is therefore an objective of the invention to provide a video communication method that is implemented with an IP phone, and allows conducting video and audio telephony.

According to an aspect of the invention, a video communication method of the invention is implemented with an IP phone. The method comprises providing a video-compatible functionality to the IP phone so that video data can be received from a remote communication terminal. When video data are received, the status of a video-processing device connected to the IP phone is detected. If the video-processing device is in an activation state, the IP phone transmits the video data to the video-processing device. Video data are processed via a video compression/decompression module of the video-processing device, to be displayed on a display module of the video-processing device. The video-processing device is further equipped with an image pickup module, that captures incoming video signals which are turned to the compressed video data through the video compression/decompression module, and then transmitted through the IP phone to the communication terminal.

According to other aspects of the invention, an IP phone comprises a telephone/video transmission interface connecting to a video-processing device for transmission of video data, a compression/decompression module, decompressing video data received from a communication terminal for display on the video-processing device, and compressing incoming video signals from the video-processing device into a video data format to be transmitted to the communication terminal. Further, a telephone control module respectively controlling voice broadcasting, data decompression and compression operations of the compression/decompression module, transmission operations of the telephone/video transmission interface, and voice and video signal integration for transmission to the communication terminal.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and is thus not limitative of the present invention, wherein:

FIG. 1 is a flowchart of a video communication method implemented according to an embodiment of the invention.

FIG. 2 is a block diagram of a video and audio communication structure implemented with an IP phone and a video-processing device according to an embodiment of the invention.

FIG. 3 is a block diagram of a video and audio communication structure implemented with an IP phone and a video-processing device according to a variant embodiment of the invention.

FIG. 4 is a block diagram of a video and audio communication structure implemented with an IP phone, an image pick-up device and a video-processing device according to a variant embodiment of the invention.

### DETAILED DESCRIPTION OF THE INVENTION

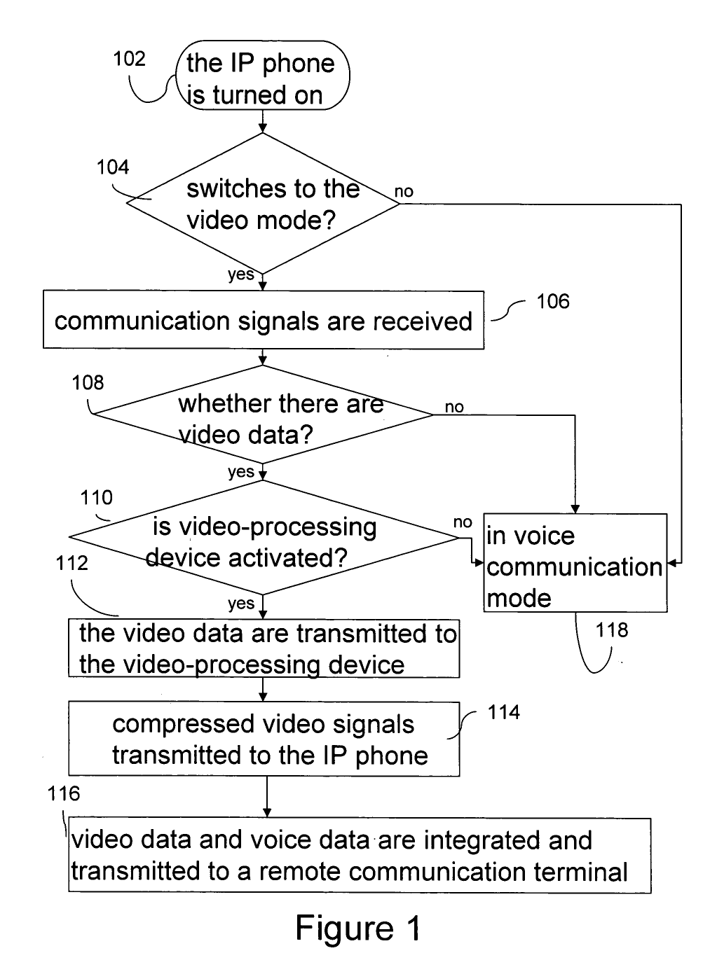

FIG. 1 is a flowchart of a video communication method for IP phone according to an embodiment of the invention. Once the IP phone is turned on (step 102), a telephone control module of the IP phone determines whether to switch to a video mode. The telephone settings are made by the user, who can choose whether to conduct a video and voice communication mode, or a voice communication mode. If the telephone is set to support video and voice communication, the IP phone switches to the video mode (step 104). Video communication can be implemented via data formats such as, for example, data compression formats H.261, H.263 defined by the International Telecommunication Union (ITU), or data compression format MPEG4 defined in the International Standard Organization (ISO) for multimedia applications. When communication signals are received (step 106), the telephone control module determines whether there are video data (step 108). If video data are received, the status of a video-processing device, being connected via a telephone/video transmission interface to the voice network telephone, is detected to determine whether the video-processing device is activated (step 110). If it is the case, the video data are transmitted via the telephone/video transmission interface to the video-processing device (step 112). A compression/decompression module of the video-processing device then decompresses the video data, and the decompressed video data are subsequently transmitted to a control module, and then are shown on the display device. The video-processing device can also receive video signals from an image pickup device, which is compressed by the compression/decompression module into video data and then transmitted via the telephone/video transmission interface to the IP phone (step 114). Once video data and voice data are integrated via the telephone control module, they are transmitted to a communication system of a remote communication terminal (step 116). The communication system can be a computer or a voice network telephone. The compression/decompression module can be compatible to video-related standards, such as ITU H.261, H.263 formats, or an MPEG4 format. In cases that the video mode is not initially selected, no video data are received, or the video-processing device is not activated, the telephone control module operates in a voice communication mode (step 118). The telephone/video transmission interface can be a USB interface or a 1394 type interface.

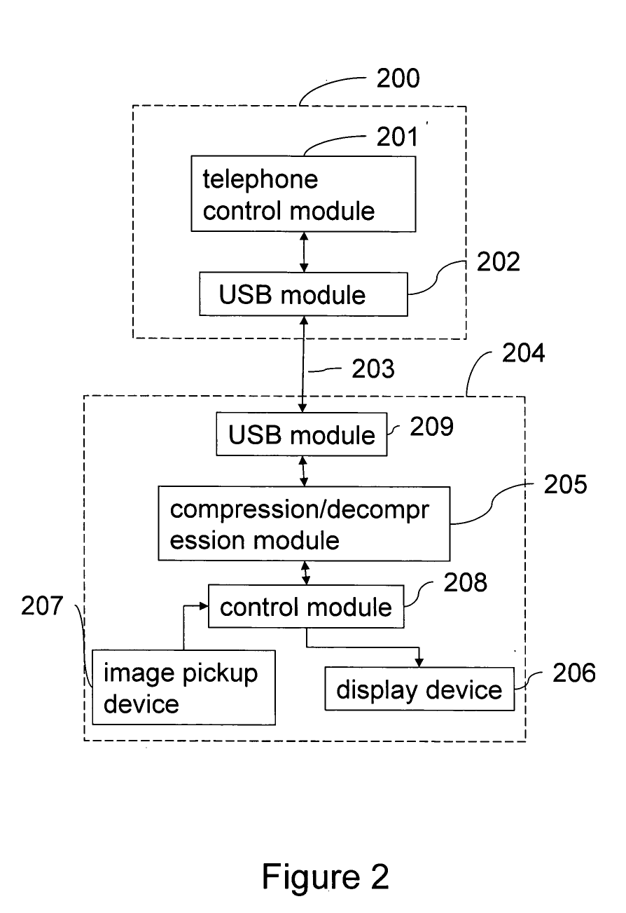

FIG. 2 is a block diagram of an embodiment of the invention, where the IP phone is not equipped with a compression/decompression module. The telephone/video transmission interface is exemplary a USB interface. However, it will be understood that the telephone/video transmission interface can be any adequate interface type, such as a 1394 type interface. In FIG. 2, the IP phone connects via a USB module to the video-processing device. When the IP phone 200 is turned on, telephone control module 201 of the IP phone 200 determines the status of the IP phone 200. For example whether it is configured to receive video and voice data signals or only voice data signals. If the IP phone is set to receive video and voice data, the telephone control module 201, while receiving communication signals, determines whether they contain video data. If video data are received, the status of a video-processing device 204 is determined via a USB module 202 and a USB connecting line 203. The video-processing device 204 connects via the USB connecting line 203 to the IP phone 200. A display device with video signal compression/decompress functionality further can connect via the USB module 202 to the IP phone 200. If the video-processing device 204 is not in an activation status, the telephone control module 201 does not process video data, and only proceeds to voice communication. If the video-processing device 204 is in an activation status, the video data are transmitted via the USB module 202 to a compression/decompression module 205 of the video-processing device 204. The received video data can include data compressed according to related formats, such as ITU compression formats H.261, H.263, or compression format MPEG4. After decompression from the compression/decompression module 205, the video data are transmitted via a control module 208 of the video-processing module 204 to the display device 206, to be broadcasted. The video-processing device 204 further can include an image pickup device 207. The control module 208 can receive incoming video data from the image pickup device 207, which then are compressed through the compression/decompression module 205 into adequate formats such as an H.261, H.263 or MPEG4 format. After compression, the video data are transmitted via the USB module 209 of the video-processing device 204, the USB connecting line 203, and the USB module 202 of the IP phone 200 to the telephone control module 201 of the IP phone 200. The telephone control module 201 integrates incoming video and audio data, and transmits them to a remote communication terminal. The video-processing device includes video data processing and broadcasting functionalities, and has a USB module connection for data transmission. The video-processing device 204 can be a computer system or a PDA, for example.

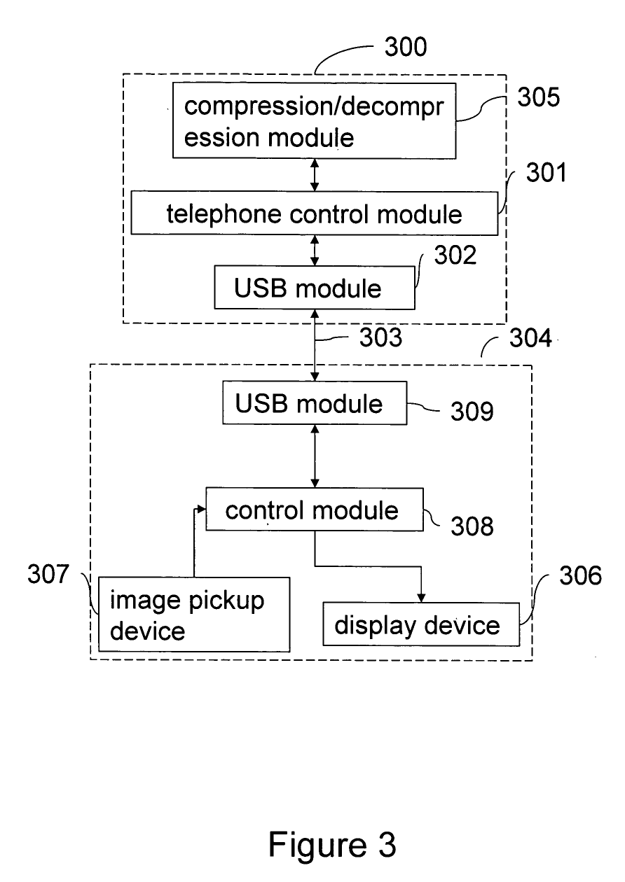

FIG. 3 is a block diagram of a variant embodiment of the invention, in which the IP phone is equipped with a compression/decompression module. The telephone/video transmission interface is exemplary a USB interface. However, it will be understood that the telephone/video transmission interface can be of any adequate interface type such as a 1394 type interface. In FIG. 3, the IP phone connects via a USB module to the video-processing device. When the IP phone 300 is turned on, a telephone control module 301 of the IP phone 300 determines the status of the IP phone 300. For example whether it is configured to receive video and voice data or only voice data. If the IP phone is set to receive video and voice data signals, the telephone control module 301, while receiving communication signals, will determine whether they contain video data. If video data are received, the status of a video-processing device 304 is determined via a USB module 302 and a USB connecting line 303. The video-processing device 304 connects via the USB connecting line 303 to the IP phone 300. If the video-processing device 304 is not in an activation status, the telephone control module 301 does not process video data, and only proceeds to voice communication. If the video-processing device 304 is in an activation status, the video data undergo decompression via a compression/decompression module 305 of the IP phone 300, and then are transmitted via the USB module 302 to the video-processing device 304. The video data compression format can be H.261, H.263 or MPEG4 format, for example. A control module 308 of the video-processing device 304 then transmits the video data to a display device 306, to be broadcasted. The video-processing device 304 further can include an image pickup device 307. The control module 308 can receive incoming video data from the image pickup device 307, the video data are transmitted via the USB module 309 of the video-processing device 304, the USB connecting line 303, and the USB module 302 of the IP phone 300 to the telephone control module 301 and the compression/decompression module 305 of the IP phone 300. Then undergo compression into adequate formats such as an H.261, H.263 or MPEG4 format. After compression, the telephone control module 301 integrates incoming video and audio data, and transmits them to a remote communication terminal. The video-processing device includes video data processing and broadcasting functionalities, and has a USB module connection for data transmission. The video-processing device 304 can be a computer system or a PDA, for example.

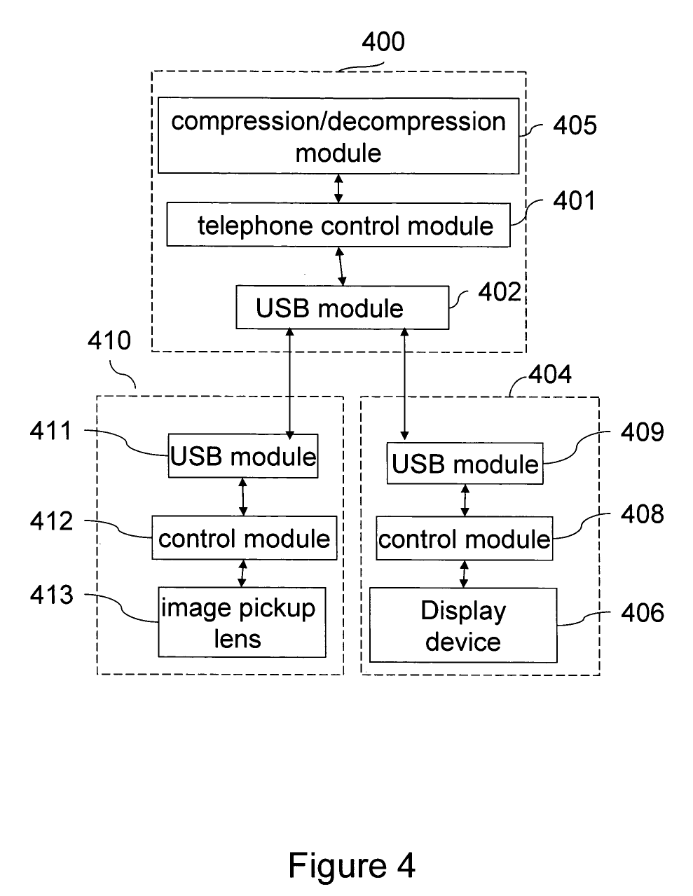

FIG. 4 is a block diagram of a variant embodiment of the invention, in which the IP phone is equipped with a compression/decompression module. And the IP phone is connected via a telephone/video transmission interface to a video-processing device and an image pick-up device respectively. The telephone/video transmission interface is exemplary a USB interface. However, it will be understood that the telephone/video transmission interface can be of any adequate interface type such as a 1394 type interface. In FIG. 4, the IP phone 400 connects via a USB module 402 to the video-processing device 404 and the image pick-up device 410 respectively. When the IP phone 400 is turned on, a telephone control module 401 of the IP phone 400 determines the status of the IP phone 400. For example, whether it is configured to receive video and voice data or only receive voice data. If the IP phone 400 is set to receive video and voice data signals, the telephone control module 401, while receiving communication signals, will determine whether they contain video data. If video data are received, the status of a video-processing device 404 is determined via a USB module 402. The video-processing device 404 connects via the USB connecting line to the IP phone 400. If the video-processing device 404 is not in an activation status, the telephone control module 401 does not process video data, and only proceeds to voice communication. If the video-processing device 404 is in an activation status, the video data undergo decompression via a compression/decompression module 405 of the IP phone 400, and then are transmitted via the USB module 402 to the video-processing device 404. The video data compression format can be H.261, H.263 or MPEG4 format, for example. A control module 408 of the video-processing device 304 then transmits the video data to a display device 406, to be broadcasted. An image pickup device 410 is separately connected to the IP phone 400 via the USB module 402. The control module 412 can receive incoming video data from the image pickup lens 413, and the video data are transmitted via the USB module 409 of the video-processing device 404, and the USB module 402 of the IP phone 400 to the telephone control module 401 and the compression/decompression module 405 of the IP phone 400. Then undergo compression into adequate formats such as an H.261, H.263 or MPEG4 format. After compression, the telephone control module 401 integrates incoming video and audio data, and transmits them to a remote communication terminal. The video-processing device includes video data processing and broadcasting functionalities, and has a USB module connection for data transmission. The video-processing device 404 can be a computer system or a PDA, for example.

It will be apparent to the person skilled in the art that the invention as described above may be varied in many ways, and notwithstanding remains within the spirit and scope of the invention as defined in the following claims.

1. A video communication method, implemented in an IP phone that connects to a video-processing device, the video communication method comprising:
determining whether the video-processing device is activated;
according to a communication received from a communication terminal, broadcasting a voice signal of the communication and transmitting a video signal of the communication to the video-processing device; and
processing and displaying the video signal on the video-processing device.

2. The video communication method of claim 1, further comprising receiving a video mode setting before determining whether the video-processing device is activated, wherein the video mode setting activates the reception of video signals.

3. The video communication method of claim 1, wherein processing and displaying the video signal on the video-processing device further comprises decompressing the video signal via a video compression/decompression module of the video-processing device, and displaying the decompressed video signal.

4. The video communication method of claim 1, wherein the video-processing device further receives and processes an incoming video signal, and transmits the incoming signal to the IP phone, the IP phone integrates the incoming video signal with an incoming voice signal that then are transmitted to the communication terminal.

5. The video communication method of claim 4, wherein incoming video signal processing in the video-processing device further comprises compressing the incoming video signal via a video compression/decompression module, and transmitting the compressed incoming video signal to the IP phone.

6. The video communication method of claim 4, wherein transmitting the incoming video signal to the IP phone is performed via a telephone/video transmission interface.

7. The video communication method of claim 1, wherein transmitting a video signal of the communication to the video-processing device is performed via a telephone/video transmission interface.

8. A video communication method, implemented in an IP phone that connects to a video-processing device, the video communication method comprising:
determining whether the video-processing device is activated;
according to a communication received from a communication terminal, broadcasting a voice signal of the communication, processing a video signal of the communication in the IP phone, and transmitted the processed video signal to the video-processing device; and
displaying the video signal on the video-processing device.

9. The video communication method of claim 8, further comprising receiving a video mode setting before determining whether the video-processing device is activated, wherein the video mode setting activates the reception of video signals.

10. The video communication method of claim 8, processing a video signal of the communication in the IP phone comprises decompressing the video signal via a video compression/decompression module for transmission to the video-processing device.

11. The video communication method of claim 8, the video-processing device further receives an incoming video signal, transmits the incoming signal to the IP phone for signal processing, the IP phone after processing the incoming video signal integrates the processed incoming video signal with an incoming voice signal, the incoming video and voice signals then are transmitted to the communication terminal.

12. The video communication method of claim 11, incoming video signal processing in the IP phone further comprises compressing the incoming video signal via a video compression/decompression module, and transmitting the compressed incoming video signal to the communication terminal.

13. The video communication method of claim 11, transmitting the incoming video signal to the IP phone is performed via a telephone/video transmission interface.

14. The video communication method of claim 8, transmitting a video signal of the communication from the communication terminal to the video-processing device is performed via a telephone/video transmission interface.

15. An IP phone, comprising:
a telephone/video transmission interface, connecting to a video-processing device for transmission of video data; and
a compression/decompression module, decompressing video data received from a communication terminal for display on the video-processing device, and compressing incoming video signals from the video-processing device into a video data format to be transmitted to the communication terminal; and
a telephone control module, respectively controlling voice broadcasting, data decompression and compression operations of the compression/decompression module, transmission operations of the telephone/video transmission interface, and voice and video signal integration for transmission to the communication terminal.

16. The IP phone of claim 15, wherein the video-processing device is a computer system equipped with a display monitor.

17. The IP phone of claim 15, wherein the telephone/video transmission interface is a USB interface.

18. The IP phone of claim 15, wherein the telephone/video transmission interface is a 1394 type interface.

19. An IP phone, comprising:
a telephone/video transmission interface, connecting to a video-processing device for transmission of video data received from a communication terminal and incoming video data received from the video-processing device; and
a telephone control module, controlling processing of communication signals from a communication terminal, wherein the telephone control module respectively controls broadcasting of voice data of the communication signals, transmission of video data of the communication signals via the telephone/video transmission interface to the video-processing device, and integration of voice data with incoming video data from the video-processing device for transmission to the communication terminal, wherein a compression/decompression module of the video-processing device performs data decompression of the video data from the communication terminal for displaying and data compression of incoming video signals into incoming video data transmitted to the telephone control module.

20. The IP phone of claim 19, wherein the telephone/video transmission interface is a USB interface.

21. The IP phone of claim 19, wherein the telephone/video transmission interface is a 1394 type interface.
